(19) United States
(12) Patent Application Publication
(10) Pub. No.: US 2013/0331078 A1
(43) Pub. Date: Dec. 12, 2013

(54) System And Method To Inhibit User Text Messaging On A Smartphone While Traveling In A Motor Vehicle

(71) Applicant: Myine Electronics, Inc., Ferndale, MI (US)

(72) Inventors: Jacob R. SIGAL, Ferndale, MI (US); Massimo BALDINI, Beverly Hills, MI (US); Peter RAYMOND, Belleville, MI (US)

(21) Appl. No.: 13/912,767

(22) Filed: Jun. 7, 2013

Related U.S. Application Data
(60) Provisional application No. 61/658,528, filed on Jun. 12, 2012.

(51) Int. Cl. H04W 8/22

(52) U.S. Cl. CPC H04W 8/22
USPC 455/418

(57) ABSTRACT

A system is disclosed for selectively inhibiting text message operation of a smartphone being used by a user while travelling in a motor vehicle, where the motor vehicle incorporates a vehicle audio subsystem. A smartphone may have a detection circuit and a processor. The detection circuit detects a signal from the audio system that indicates to the smartphone that the smartphone is located within the vehicle. A navigation system may also be included in the smartphone that generates navigation signals indicating when the smartphone is in motion. The processor receives the navigation signals and, using a software module, inhibits text messaging operation on the smartphone while the vehicle is detected to be in motion.

### CROSS-REFERENCE TO RELATED APPLICATIONS

This application claims the benefit of U.S. Provisional Application No. 61/658,528, filed on Jun. 12, 2012. The entire disclosure of the above application is incorporated herein by reference.

### FIELD

The present disclosure relates to smartphones, and more particularly to a system and method by which user text messaging on a smartphone can be disabled while a user is travelling in a motor vehicle and the user's smartphone is connected to an auxiliary input of the vehicle's audio system.

### BACKGROUND

The statements in this section merely provide background information related to the present disclosure and may not constitute prior art.

With the dramatically growing popularity of smartphones and texting, the frequency with which smartphone user's either receive text messages, or have occasion where they desire to send text messages, is increasing. When a smartphone user is travelling in a motor vehicle such as a car or truck, this can present potential issues. When receiving a text message, a user operating a motor vehicle may be tempted to pick up his/her smartphone and read the text message, and possibly to draft a response, while operating the vehicle.

Frequently, users also will couple their smartphone via a standard AUX audio cable to the “Auxiliary” input of their vehicle audio system. This enables audio content wirelessly received by the user's smartphone to be played over the vehicle's audio system. Present day smartphones, as well as present day vehicle audio systems, each have the ability to automatically sense when an AUX audio cable is coupled to their respective auxiliary input (or output, as with a smartphone). When a standard AUX cable is coupled to a smartphone's “Line Out” port (commonly used as a headphone jack as well), the smartphone typically disables its internal speaker so that the audio content is directed solely to its “Line Out” port.

It will also be appreciated that many present day smartphones also have an on-board navigation application (i.e., both hardware and software). The on-board navigation application can detect movement of the smartphone for the purpose of plotting location and movement of the smartphone against a suitable map.

In view of the foregoing, it would be highly desirable if some type of system and/or method could be created to use the intelligence provided by a smartphone when it detects that it is coupled to a vehicle's audio system, as well as its on-board navigation system, in a manner that helps to control use of the smartphone while it is physically coupled to the vehicle's audio system.

### SUMMARY

In one aspect the present disclosure relates to a system for selectively inhibiting text message operation of a smartphone being used by a user while travelling in a motor vehicle, where the motor vehicle incorporates a vehicle audio subsystem. The system may comprise a smartphone present including a detection circuit and a processor. The detection circuit may be used for detecting a signal from the audio system that indicates to the smartphone that the smartphone is located within the vehicle. The processor may be in communication with the detection circuit and configured to run a software module. A navigation system may also be included in the smartphone. The smartphone may be in communication with the processor and the navigation system may operate to generate navigation signals indicating when the smartphone is in motion. The processor may further be configured to receive the navigation signals and to inhibit text messaging operation on the smartphone while the vehicle is detected to be in motion.

In another aspect the present disclosure relates to a system for selectively inhibiting text message operation of a smartphone being used by a user while travelling in a motor vehicle. The system may comprise a vehicle audio system configured to output at least one of a pulsed tone or a continuous tone from an output thereof. A smartphone may be included which is present within the vehicle. The smartphone may include a port for receiving the at least one of a pulsed tone or a continuous tone from the vehicle radio system via a conductor coupling the port of the smartphone to the output of the vehicle audio system, and where the at least one of a pulsed tone or a continuous tone indicates that the smartphone is present within a vehicle. A processor may be included which is configured to run a software module. The processor may further be configured to receive a navigation signal indicating when the smartphone is experiencing motion and to inhibit text messaging operation on the smartphone while the vehicle is in motion.

In still another aspect the present disclosure relates to a method for inhibiting text messaging on a smartphone while the smartphone is detected as being located within a vehicle and in motion. The method may comprise using the smartphone to receive a signal from the vehicle when the smartphone is within the vehicle, the signal indicating to the smartphone that the smartphone is present within the vehicle. A navigation system may be used to provide navigation signals to the smartphone which the smartphone uses to deduce that it is in motion, and thus that the vehicle is moving. When the smartphone is detected as being present within the vehicle and in motion, then text messaging operation on the smartphone may be inhibited. The method may further include detecting, based on the navigations signals, when the smartphone is no longer in motion and then re-enabling text messaging operation on the smartphone.

### BRIEF DESCRIPTION OF THE DRAWINGS

The drawings described herein are for illustration purposes only and are not intended to limit the scope of the present disclosure in any way.

FIG. 1 is a block diagram of one embodiment of a system in accordance with the present disclosure showing how user text messaging may be controllably inhibited on a smartphone while the smartphone is coupled to an “AUX Comm” jack of an audio system of a vehicle, and while the smartphone's navigation electronics system detects that the vehicle is moving; and

FIG. 2 is a flowchart illustrating various operations that may be performed by the system shown in FIG. 1 to controllably inhibit user text messaging on the smartphone while the vehicle is detected as moving.

### DETAILED DESCRIPTION

The following description is merely exemplary in nature and is not intended to limit the present disclosure, application, or uses. It should be understood that throughout the drawings, corresponding reference numerals indicate like or corresponding parts and features.

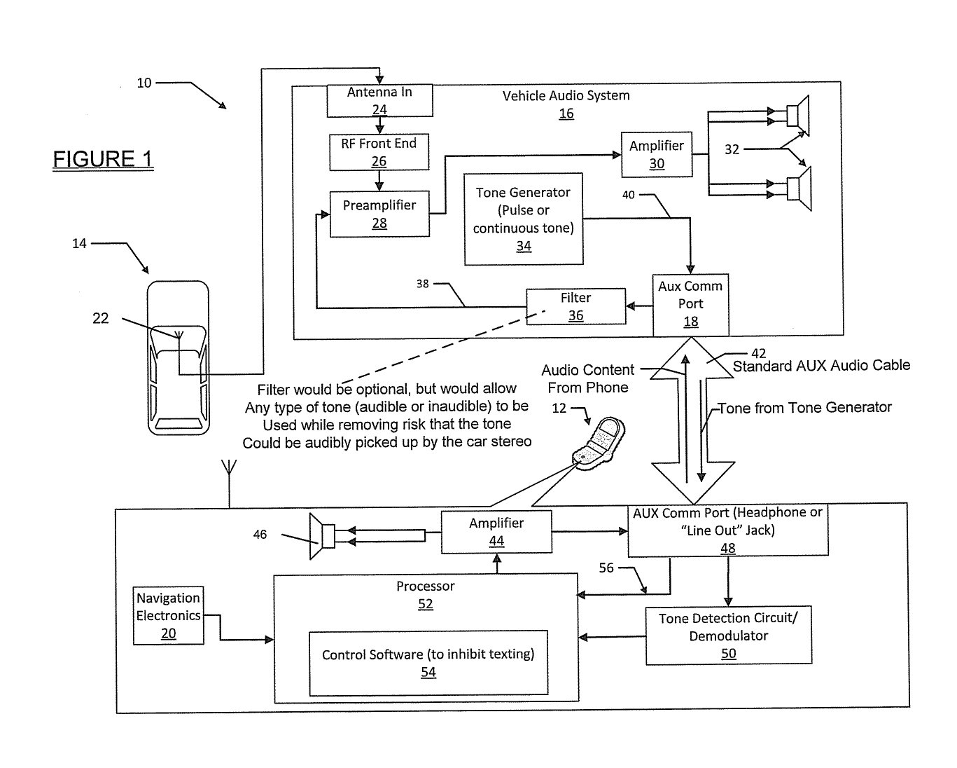

Referring to FIG. 1, there is shown a system 10 in accordance with one embodiment of the present disclosure. The system 10 may be implemented in a present day smartphone 12 to inhibit texting on the smartphone while the smartphone is coupled to an “AUX Comm” port/jack 18 of an audio system 16 of a vehicle 14, and while the smartphone's navigation electronics system 20 detects that the vehicle is moving. Merely by way of example, the vehicle audio system 16 may include an antenna 22 that is coupled to an antenna input 24. An RF front end 26 receives the signal received by the antenna 24 and feeds it to a preamplifier 28. The preamplifier 28 may output the signal to an amplifier 30 where the audio signal is amplified before being output to one or more speakers 32. For the purpose of the present disclosure, a tone generator 34 may be included in the vehicle audio system 16 for generating a tone (either continuous or an intermittent pulse) which is applied to the Aux Comm port 18 of the vehicle audio system 16 via signal line 40. The tone generator 34 may be any suitable oscillator that produces a tone, either continuous or intermitted, at a desired frequency that is inaudible to the human ear. Typically such inaudible frequencies are those below about 20 Hz as well as those above about 20 KHz. Optionally, a filter 36 may be included to filter out any portion of the tone signal from tone generator 34 that may leak out or otherwise be directed into the preamplifier 28 via signal line 38. The preamplifier 28 thus receives both the signal on signal line 40 from the tone generator 34 as well as the audio content signal from a standard AUX audio cable 42. It will be appreciated that the foregoing has only been intended as a highly simplified description of various elements that the vehicle audio system 16 may include. In actual practice the vehicle audio system 16 will typically include various other components (e.g., a processor; signal conditioning/mixer components, user interface/controls, display, etc.) that are commonly used with present day vehicle audio systems. However, for the purpose of describing the subject matter of the present disclosure, a discussion of such other commonly included components of a typical vehicle audio system is not necessary.

The smartphone 12 may include components such as an amplifier 44, a speaker 46, an auxiliary communication port (“AUX Comm” port) 48, sometimes referred to as a “Headphone Jack” or a “Line Out” port. The AUX Comm port 48 may be coupled to the standard AUX audio cable 42 to place the smartphone 12 in communication with the vehicle audio system 16. The smartphone 12 may also include a tone detection circuit/demodulator 50 that receives an input signal from the AUX Comm port 48 and generates an output/control signal to a processor 52. The processor 52 also may include suitable control software (i.e., a custom application) that runs on the processor 52 that may be used for controllably inhibiting user text messaging on the smartphone while the vehicle 14 is detected to be in motion. This important feature of the system 10 will be described in greater detail in the following paragraphs.

With further reference to FIG. 1, the smartphone 12 may the include navigation electronics 20, which may be a Global Positioning System (GPS) chipset or any other suitable navigation system for working with remote signal generation systems (either satellite or terrestrial based broadcast systems). In either event, the remote signal system provides signals that enable the navigation electronics 20 to detect that the smartphone 12 is moving, and typically further to track the movement of the smartphone relative to a map (either stored on the smartphone or wirelessly downloaded provided to the smartphone 12). The processor 52 is also able to detect when the standard AUX audio cable 42 is coupled to the AUX Comm port 48 via a signal on line 56. This may be done by a suitable, well known impedance sensing circuit (not shown) or by any other suitable means of detection. It is also possible that if the vehicle 14 has its own navigation system on-board, that a suitable signal could be provided to the vehicle's on-board computer control module, which could then be used by the smartphone 12 in place of its own navigation system to detect when the vehicle 14 is in motion. However, it is contemplated that the most likely implementation will be the first one discussed above, where the smartphone 12 uses its own navigation system to detect when the smartphone (and thus the vehicle 14) is moving. Those skilled in the art will appreciate that there may be other ways to detect when the vehicle 14 is in motion as well.

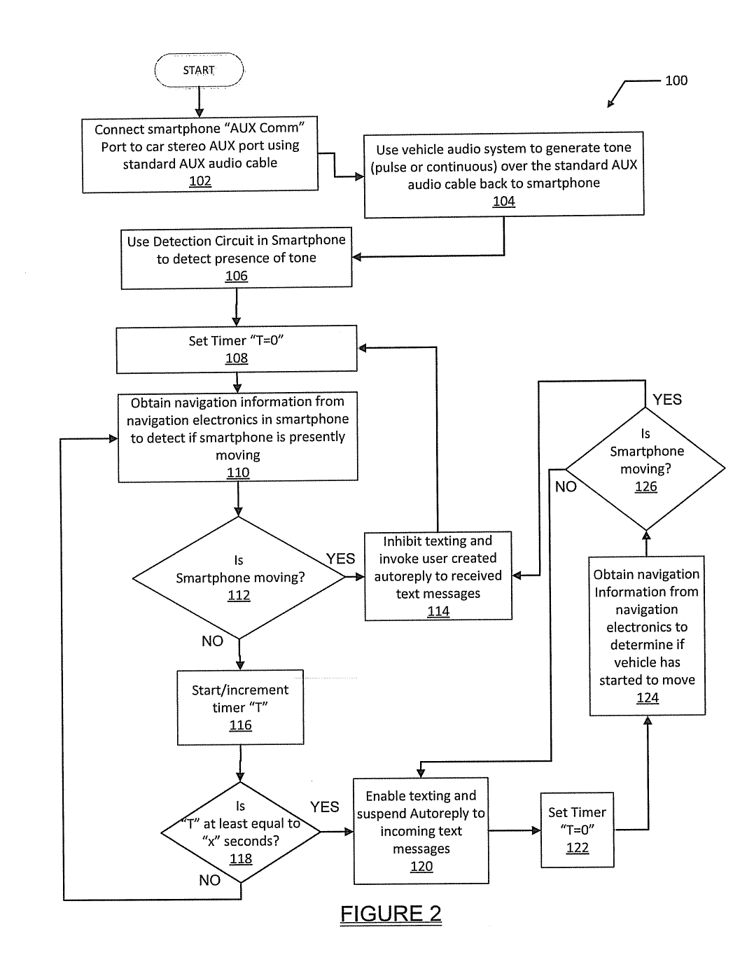

Referring now to FIG. 2 a flowchart 100 is illustrated that shows a plurality of operations that may be performed by the system 10 to detect when the vehicle 14 is in motion, and when user texting on the smartphone 12 is to be inhibited. At operation 102 a vehicle user first connects the smartphone AUX Comm port 48 to the vehicle's AUX Comm port 18 using the standard AUX audio cable 42. This enables audio content to be transmitted from the smartphone 12 to the vehicle audio system 16, as well as the tone generated by tone generator 34 to simultaneously be sent to the smartphone 12. As mentioned above, the frequency of the tone generated by the tone generator 34 is selected to be either above or below the audible range that the human hear can perceive, and as such it will be inaudible to the user while the user is listening to the playback of audio content being played back on the speakers 32 of the vehicle audio system 16. The presence of optional filter 36 may further ensure that no harmonics or other elements of the tone signal from tone generator 34 are picked up by the preamplifier 28 and amplified. It will also be appreciated that the tone coming from the vehicle 14 could be broadband or narrowband, as well as continuous or pulse, or even possibly pseudo-random noise or possible in the nature of a sine-wave. Thus, the tone could potentially be equally effective as a noise spectrum across the audible frequency range.

With continued reference to FIG. 2, at operation 104 the vehicle audio system 16 generates the tone signal from tone generator 34, which is sent over the standard AUX audio cable 42 to the smartphone 12. At operation 106 the tone detection circuit 50 in the smartphone 12 may be used to monitor and detect the presence of the tone signal from the tone generator 34. At operation 108 a timer implemented via the control software 54 is set to “0” (i.e., initialized). At operation 110 navigation information may be obtained from the navigation electronics 20 in the smartphone 12 to determine if the smartphone is presently moving. At operation 112 a determination is made from the navigation information if the smartphone 12 is moving. If the answer is “yes”, then at operation 114 user texting is immediately inhibited. A user created autoreply text message (e.g., “I am currently operating my vehicle; I will respond later”) may also be automatically generated by the control software 54, and sent from the smartphone 12, in response to any incoming text messages received while the vehicle 14 is sensed to be moving. Operations 108-112 may then be repeated to continue sensing whether the vehicle is still in motion. Operations 108-112 may be repeated at a relatively high frequency, for example once every 10 ms-1 second, although the precise selected frequency may be varied. The precise frequency selected may be determined on a number of factors including the speed of the processor 52 and how quickly the navigation electronics 20 can update the sensed position of the vehicle 14.

If at operation 112 a determination is made from the monitored navigation signals that the vehicle 14 is no longer moving, then the timer mentioned at operation 108 is started or incremented, as indicated at operation 116. A check is then made at operation 118 to determine if the timer count is at least equal to a predetermined time period “X”, for example 30 seconds. This predetermined time period may be designed into the control software 54 and represents the passage of a time duration where it can be safely assumed that the vehicle 14 is not just momentarily sitting at a stop sign or at a stop light, but is in fact parked. So if the check at operation 118 produces a “yes” response, then at operation 120 user text messaging is then enabled and the sending of the autoreply message is suspended. The timer may thereafter be reset to “0”, as indicated at operation 122. Operation 124 involves again obtaining navigation data from the navigation electronics 20, and operation 126 involves again using the processor 52 to determine if the vehicle 14 is moving. As long as the check at operation 126 determines that the vehicle is still stationary, then user text messaging will be enabled. But as soon as the check at operation 126 determines that the vehicle 14 has again started to move, then operations 114, 108, 110 and 112 will be repeated.

It will be appreciated that the timer feature described herein at operations 108, 116, 118 and 122 is optional, but the timer allows automatically removing the text message inhibiting action without any further action by the user. So in one example, if a user is driving the vehicle 14 on a road and then pulls off the road and into a parking lot and stops, after the predetermined time period (in this example 30 seconds) has elapsed the smartphone 12 will automatically allow the user to begin text messaging with the smartphone 12. In other words, the user is not required to disconnect the standard AUX audio cable 42 or to take any other action to remove the text inhibiting feature. When the user again starts driving the vehicle out of the parking lot, the text inhibiting feature will be re-implemented, and will stay implemented until the vehicle again comes to a stop for the predetermined time period. When selecting the duration of the predetermined time period, a duration of 25-30 seconds is expected to be sufficient to account for those situations where the user may momentarily stop at a stop light or stop sign. Of course, in any emergency where the user needs to immediately send a text message, the user may simply pull out the standard AUX audio cable 42 from the AUX comm port 48 of the smartphone. The processor 52 and the control software 54 will immediately sense that the smartphone 12 is no longer connected to the vehicle 14, and the text inhibiting control methodology shown in FIG. 2 will be turned off. If the user then replugs the standard AUX cable 42 into the smartphone's AUX comm port 48, then the methodology described in FIG. 2 may start again at operation 102.

The embodiments of the present system 10 and the methodologies described herein thus enable user text messaging from a smartphone to be automatically inhibited, as well as automatically re-started, in accordance with sensed vehicle movement. An advantage is that most present day smartphones already include some navigation electronics, so the only significant modification to the smartphone required would be the installation of a suitable program to inhibit/re-enable text messaging from the smartphone, based on the navigation signals received as well as the presence of the standard AUX comm cable being connected to the smartphone's AUX comm port.

It will also be appreciated that movement of the vehicle could also be deduced simply be detecting if the vehicle transmission has been placed in “Park” in a vehicle with an automatic transmission, or possibly by detecting that a parking brake has been engaged on a vehicle with a manual transmission. In the case of an automatic transmission, signals indicating the engagement of “Park” may be available from the vehicle's engine control module, and may potentially be obtainable simply by tapping into one or more conductors of the vehicle's wiring harness. Similarly, engagement of the parking brake can be detected through an output of a sensor that is commonly used to indicate that a parking brake is engaged. In either event, the control software 54 and the processor 52 could monitor these signals and controllably inhibit and allow user text messaging based on when the vehicle is sensed to be moving and when it is sensed to be parked. It is possible that two tones could be utilized, one to indicate simply that the smartphone is connected to the AUX Comm port of the vehicle's AUX comm port 18, and a second tone to indicate that the vehicle is moving, possibly by the vehicle detecting that the engine is running and the vehicle is not in park (or does not have its parking brake engaged). Such an option would mean that use of the smartphone's navigation system or even the use of the vehicle's navigation system is not required.

Still further, the passenger seat air bag system used in many modern day passenger cars and light trucks, which senses if an occupant is seated in the passenger seat, could potentially be used to provide an “override” to the text inhibiting feature discussed herein. By “override” it is meant that the system and method described herein could be modified such that the text inhibiting feature is disabled if an occupant is sensed to be seated in the passenger seat of the vehicle. The sensing of the occupant in the passenger seat of the vehicle would be accomplished by the vehicle's electronics, and the system and method of the present disclosure could read this signal from the vehicle computer, or possibly read it from the appropriate conductor(s) of the vehicle's wiring harness. If this system was not in place, application developers and/or operating system developers could write an override process that could allow a passenger to disable the text inhibiting feature. In this manner texting could be enabled even if the smartphone is coupled to the vehicle's AUX comm port 18 whenever an occupant is sensed to be seated in the passenger seat of the vehicle. This would allow a passenger riding in the vehicle (i.e., not the driver) to text while the smartphone is connected to the vehicle's AUX comm port 18.

It will also be appreciated that for the various embodiments discussed above, the smartphone 12 would likely need to have an application that is full-duplex. This means that the smartphone 12 would be able to play back and record (or monitor) inputs simultaneously. Another option would be a hardware option that is implemented before the smartphone operating system (OS) level to detect a tone and cause the smartphone 12 to enter a specific mode in which texting is disabled.

Various methods for encoding/detecting signals within digital audio that could be utilized are audio steganography, which involves concealing information in digital audio transmission by:

LSB coding;

Parity Coding;

Phase Coding;

Spread Spectrum Coding; and/or

Echo Hiding.

Audio summing could also be used, which involves adding the tone (continuous or pulse) to the existing music (i.e., or other audio content being listened to). Frequency or Amplitude Modulation (FM or AM synthesis).

While various embodiments have been described, those skilled in the art will recognize modifications or variations, which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A system for selectively inhibiting text message operation of a smartphone being used by a user while travelling in a motor vehicle, wherein the motor vehicle incorporates a vehicle audio subsystem, the system comprising
a smartphone present including:
a detection circuit for detecting a signal from the audio system that indicates to the smartphone that the smartphone is located within the vehicle;
a processor in communication with the detection circuit and configured to run a software module;
a navigation system in communication with the processor for generating navigation signals indicating when the smartphone is in motion; and
the processor further configured to receive the navigation signals and to inhibit text messaging operation on the smartphone while the vehicle is detected to be in motion.

2. The system of claim 1, wherein the detection circuit is configured to detect the signal from the audio system, and wherein the signal comprises at least one a pulsed tone or a continuous tone.

3. The system of claim 2, further comprising:
a port on the smartphone; and
a conductor, the port configured to couple to the conductor and the conductor configured to transmit the at least one of a pulsed tone or a continuous tone to the smartphone.

4. The system of claim system of claim 1, further comprising a software module configured to run on the processor and to inhibit the text messaging when the smartphone is detected to be in motion.

5. The system of claim 1, wherein the software module further is configured to implement a time delay of a predetermined duration once motion of the smartphone has ceased, before re-enabling text messaging on the smartphone.

6. A system for selectively inhibiting text message operation of a smartphone being used by a user while travelling in a motor vehicle, the system comprising
a vehicle audio system configured to output at least one of a pulsed tone or a continuous tone from an output thereof;
a smartphone present within the vehicle, the smartphone including:
a port for receiving the at least one of a pulsed tone or a continuous tone from the vehicle radio system via a conductor coupling the port of the smartphone to the output of the vehicle audio system, the at least one of a pulsed tone or a continuous tone indicating that the smartphone is present within a vehicle;
a processor configured to run a software module;
the processor further configured to receive a navigation signal indicating when the smartphone is experiencing motion; and
the processor further being configured to inhibit text messaging operation on the smartphone while the vehicle is in motion.

7. The system of claim 6, wherein the output of the vehicle audio system comprises an auxiliary communications port.

8. The system of claim 6, wherein the vehicle radio system comprises a tone generator for generating the at least one of a pulsed tone or a continuous tone.

9. The system of claim 6, wherein the port of the smartphone comprises at least one of:
an auxiliary communications port;
a line out port; and
a headphone jack.

10. The system of claim 6, wherein the smartphone includes a navigation electronics subsystem for generating the navigation signal.

11. The system of claim 6, wherein the smartphone includes a tone detection circuit for receiving the at least one of a pulsed tone or a continuous tone and generating therefrom a signal to the processor in accordance therewith.

12. The system of claim 6, wherein the vehicle radio system further includes:
a filter for filtering the at least one of a pulsed tone or a continuous tone to produce a filtered tone; and
a preamplifier for receiving the filtered tone.

13. The system of claim 6, wherein the software module is further configured to wait a predetermined time period after the smartphone is determined to have stopped being in motion, before allowing test messaging to be re-enabled on the smartphone.

14. The system of claim 6, wherein when the text messaging is inhibited the smartphone is controlled to respond to incoming text messages using an autoreply.

15. A method for inhibiting text messaging on a smartphone while the smartphone is detected as being located within a vehicle and in motion, the method comprising:
using the smartphone to receive a signal from the vehicle when the smartphone is within the vehicle, the signal indicating to the smartphone that the smartphone is present within the vehicle;
using a navigation system to provide navigation signals to the smartphone which the smartphone uses to deduce that it is in motion, and thus that the vehicle is moving; and
when the smartphone is detected as being present within the vehicle and in motion, inhibiting text messaging operation on the smartphone; and
based on the navigations signals, detecting when the smartphone is no longer in motion and re-enabling text messaging operation on the smartphone.

16. The method of claim 15, wherein said using the smartphone to receive a signal from the vehicle comprises using the smartphone to receive one of a pulsed tone signal or a continuous tone signal via a conductor electrically coupling an audio system of the vehicle to the smartphone, and wherein receipt of the one of the pulsed tone signal or continuous tone signal informs the smartphone that the smartphone is present within the vehicle.

17. The method of claim 15, further comprising coupling one end of the conductor to an auxiliary port of the audio system, and coupling another end of the conductor to a jack on the smartphone.

18. The method of claim 15, wherein said using a navigation system to provide navigation signals to the smartphone comprises using a navigation system within the smartphone.

19. The method of claim 15, further comprising implementing a time delay after the smartphone is detected as no longer being in motion, before re-enabling the text messaging operation of the smartphone.
